(19) United States
(12) Patent Application Publication
(10) Pub. No.: US 2003/0164583 A1
(43) Pub. Date: Sep. 4, 2003

(54) Bonded fibrous materials

(76) Inventors: Paul Nigel Eaton, Worcestershire (GB); Craig John Freeman, Worcestershire (GB)

Correspondence Address: JOHN S. PRATT, ESQ, KILPATRICK STOCKTON, LLP, 1100 PEACHTREE STREET, SUITE 2800, ATLANTA, GA, 30309, US

(21) Appl. No.: 10/343,406

(22) PCT Filed: Aug. 2, 2001
(86) PCT No.: PCT/GB01/03487

(30) Foreign Application Priority Data
Aug. 4, 2000 (GB) 0019268.2
Dec. 1, 2000 (GB) 0029384.5
Mar. 15, 2001 (GB) 0106474.0

(51) Int. Cl. B28B 5/00; B28B 1/00; C04B 35/10; C04B 35/18; C04B 35/44

(52) U.S. Cl. 264/670; 501/153

(57) ABSTRACT

A refractory material comprising a strontium aluminate refractory fibre and an inorganic binder comprises when fired greater than 35 wt % strontium oxide and/or Al₂O₃=aluminium oxide content of strontium aluminate fibre ±65 wt %, SiO₂=silicon oxide content of strontium aluminate fibre ±20 wt %

This invention relates to bonded fibrous materials and is particularly applicable to materials comprising saline soluble fibres bonded with a binder.

Refractory ceramic fibres (RCF) are well known materials and typically comprise an alumino-silicate inorganic fibre formed from an oxide melt which is spun, blown, drawn, or otherwise formed into fibres. Such RCF fibres are used in the manufacture of various industrial and domestic articles. Typical uses of RCF are for applications in which resistance to temperatures in excess of 800° C. is required.

Much RCF fibre is used in the form of needled blankets of fibre in which structural integrity is provided by the fibres that are tangled together in the needling process. (Such products are known as “blanket”). Sometimes a binder is used to lock the fibres together subsequent to exposure to high temperature. Blanket can be processed further to form cut shapes or folded to form insulating modules.

RCF fibre is also used in the production of so-called “Converted Products”. Converted products comprise materials in which the RCF is processed further to provide materials in which the RCF is present as either a minor or major constituent. Typical converted products include the following:

| | |
|---|---|
| “Board” | substantially rigid flat sheets containing inorganic and/or organic binders |
| | produced by a wet process (for example made by dehydrating a suspension |
| | of RCF and binders); |
| “Paper” | a flexible fibrous insulating material with a thickness of less than or equal |
| | to 6 mm, formed on paper making machinery (for example RCF in sheet |
| | form with a binder); |
| “Shapes” | substantially rigid shapes made of ceramic fibre with the addition of |
| | inorganic and/or organic binder, fired or unfired (for example, RCF formed |
| | by vacuum forming into a variety of shapes); |
| “Fire shapes” | RCF formed by a vacuum forming route and used for domestic and |
| | industrial fires either as radiant bodies or for decorative appearance; |
| “Castables” | ceramic fibre with inorganic and/or organic binder which may be cast (for |
| | example, RCF in the form of cements, concretes and mortars); |
| “Mastics” | A mouldable material containing RCF with binders and which may be |
| | trowelled, hand moulded, or dispensed from a pressure gun and which sets |
| | upon drying/heating; |
| “Extrusion” | A mastic-like material that may be used in the manufacture of extruded |
| | sections and tubes; |
| “Textiles” | ceramic fibre which has been woven with or without the addition of other |
| | filaments, wires, or yarns (for example, RCF formed into rope, yarn, mats |
| | and the like by textile technology). |

In many of the above mentioned applications binders are used. There are two broad classes of binders:

| | |
|---|---|
| “Organic binders” | which serve to improve the handling characteristics of the product |
| | concerned at low temperatures but which burn off at higher |
| | temperatures. Organic binders include, for example, such materials as |
| | starch. |
| “Inorganic binders” | which may be effective to improve the handling characteristics of the |
| | product concerned at low temperatures, but which also give integrity to |
| | the product after exposure to high temperatures. Inorganic binders |
| | include, for example, such materials as colloidal silicas, aluminas, and |
| | clays. |

All of the above materials and concepts are well known in the refractory industry.

In recent years, a number of different types of fibre have been proposed which are refractory and yet soluble in body fluids. Among these fibres are the strontium aluminate fibres disclosed in WO96/04214. A preferred range of compositions specified in WO96/04214 was that the fibres comprise at least 90%, preferably at least 95%, by weight SrO, Al₂O₃, and a fibre forming additive, and had a composition comprising:

| | |
|---|---|
| SrO | 41.2 wt. % - 63.8 wt. % |
| Al₂O₃ | 29.9 wt. % - 53.1 wt. %. |

The applicant's currently preferred composition is:

| | |
|---|---|
| SrO | 58 ± 0.5 wt. % |
| Al₂O₃ | 30 ± 0.5 wt. % |
| SiO₂ | 12 ± 0.5 wt. % |

incidental impurities<3 wt %, preferably less than 2wt%, more preferably less than 1 wt %, which shows a good compromise between formability (the SiO₂ giving ease of manufacture) and high temperature performance.

As a fibre, these fibres are useable at temperatures in excess of 1260° C. and some are useable at temperatures in excess of 1400° C. or even in excess of 1500° C. However, problems arise in trying to make converted products including inorganic binders.

Converted products including inorganic binders have to meet several criteria. These criteria include: the shrinkage of the converted product on firing (which should be low); the strength of the converted product both in the green and when fired (which should be high); and the density of the converted product (which, for a given level of thermal conductivity, should be low so as to keep the thermal mass low).

Inorganic binders conventionally used for RCF or other silicate fibres include colloidal silicas, clays, phosphates, and phosphonates. These materials seem to be incompatible with strontium aluminate fibres because:

phosphates and phosphonates migrate in wet processing of the materials to give a converted product containing relatively high surface concentrations but relatively low concentrations in the core of the converted product (and hence low strength and machineability of the converted product)

it is difficult to get high enough concentrations of phosphates and phosphonates in the converted product for adequate strength without reducing refractoriness

colloidal silicas and clays do not migrate, but react with the fibres at temperatures of 1400° C. or more.

The present invention has as its object the provision of binders that do not migrate to the same extent as phosphates or phosphonates, and which do not react adversely with the fibres to the same extent as colloidal silicas and clays.

Accordingly, the present invention provides a refractory material comprising a strontium aluminate refractory fibre and an inorganic binder comprising when fired greater than 35 wt % strontium oxide.

Preferably the inorganic binder has the composition when fired (based upon the amounts of strontium, aluminium and silicon present calculated as oxide) comprising:

Al₂O₃ aluminium oxide content of strontium aluminate fibre±65 wt %

SiO₂ silicon oxide content of strontium aluminate fibre ±20 wt %.

Further features of the invention will be apparent from the claims and the following description with reference to the drawings in which:

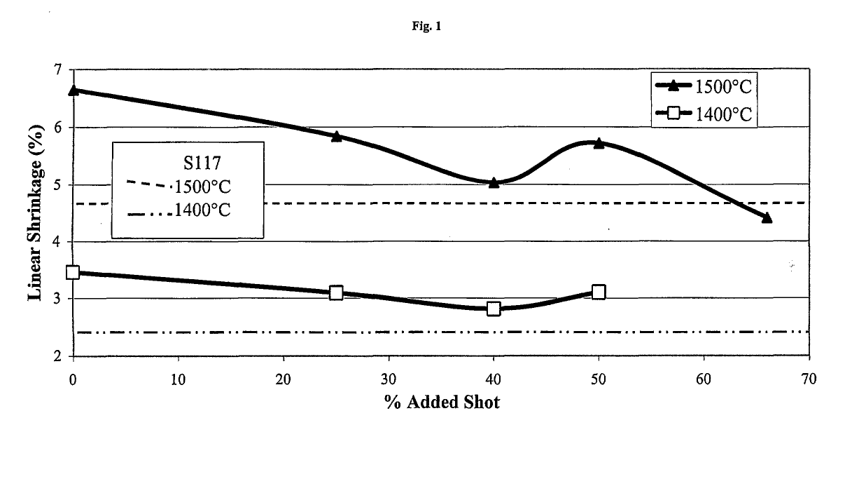

FIG. 1 is a graph of linear shrinkage against added shot for a series of boards made in accordance with the invention; and,

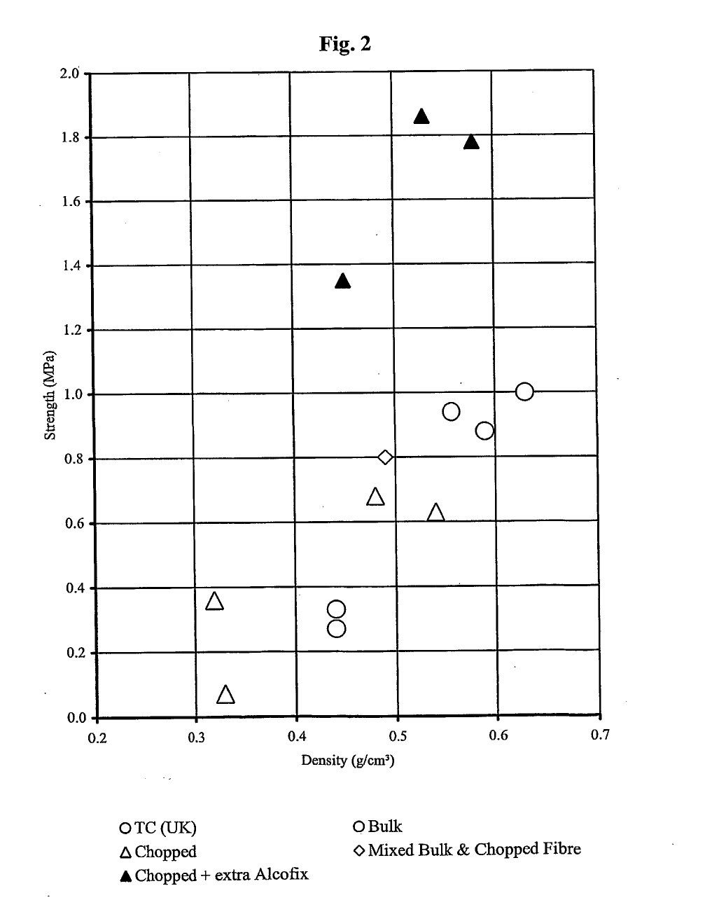

FIG. 2 is a graph of transverse bending strength against density for a series of boards in accordance with the invention.

The invention is illustrated in the following description with reference to board, but is applicable to shapes, fire shapes, and any other converted product including an inorganic binder.

The most common conventional method of forming converted products such as board is by vacuum forming, in which a dilute slurry of inorganic fibres (typically alumino-silicate fibres) is prepared, typically containing anionic colloidal silica. On addition of cationic starch flocculation takes place due to the attraction of the opposing electrical charges and discrete agglomerates of fibre, starch, and colloidal silica are formed (known as flocs).

When a meshed (male or female) mould is placed in to the forming tank and a vacuum applied, the flocs are drawn down on to the mesh. When the mould has filled sufficiently it is removed from the slurry and a vacuum applied for a further period to remove as much water as possible. The resulting shape containing approximately 40%-50% water is carefully removed and dried and the process water is recycled.

A series of boards were made to test various binders and it was found that soluble binders such as phosphates and phosphonates are retained in the water too much, and getting a significant pick up of binder requires the use of high concentrations in the slurry. Such high concentrations reduce refractoriness leading to excessive shrinkage at high temperature. Even when a reasonable amount of binder is incorporated into the material it migrates during drying to form a surface having a relatively high binder content and a core having a relatively low binder content. This results in a product that is weak, and that on machining becomes weaker still if the surface is removed (as is often required in practice). Colloidal silica binders reacted adversely with the fibres resulting in high shrinkages. The inventors realised that by using a particulate binder with a chemistry close to that of the fibre such problems might be avoided as this will reduce concentration gradients between binder and fibre.

### EXAMPLE 1

Accordingly, a further series of tests were made using a range of particulate binders and a spun fibre having a nominal composition SrO 58 wt %, Al₂O₃ 30 wt % and SiO₂ 12 wt %. Table 4 shows x-ray fluorescence analyses of three samples of thus fibre together with the mean composition. As made, fibre contains varying amount of particulate material (shot) which can result in variation in properties. Accordingly, the fibre was deshotted by hand (sieved) so as to produce a consistent material for these tests but this is not necessary to the invention.

The recipes for the boards used in these tests are given in Table 1 below showing amounts used by weight. The fibre, water and inorganic particulate materials were mixed together before the starch was added for flocculation. (The starch was chosen as anionic or cationic according to whether the clay was cationic or anionic respectively. Either starch may work with an amphoteric clay). This was then followed by adding latex (Acronal Latex LA420S) and finally flocculating again with Percol 230L (0.2% soln., polyacrylamide-based flocculant).

Table 2 shows x-ray analyses of the compositions of the inorganic constituents used, together with colloidal aluminas shown in other tests to be effective but not exemplified. Table 3 below shows the observed board shrinkages, the calculated inorganic binder composition (referring only to SrO, Al₂O₃ and SiO₂ content) and the deviation of the binder composition from the fibre composition (i.e. the absolute values of binder content less fibre content in weight percent for SrO, Al₂O₃, and SiO₂).

In Table 3 the first four compositions (D092, D095, D097 and D096) deviate from the SiO₂ content of the fibre by more than 20% and have high shrinkage at a temperature of 1400° C. These compositions are ranked according to the deviation of the SiO₂ content of the inorganic binder from the content of the fibre and it can be seen that the more remote the SiO₂ content of the inorganic binder from the fibre, the worse the linear shrinkage.

The next composition (D091) has a close SiO₂ content to that of the fibre, but deviates from the Al₂O₃ content of the fibre by 70.6% and the SrO content by 57.8%. This composition has a moderately high shrinkage.

The next composition (D090) has a close SiO₂ content to that of the fibre but deviates from the Al₂O₃ content of the fibre by 29.4% and from the SrO content by 42.2%. This composition has an acceptably low shrinkage at 1400° C. but a high shrinkage at 1500° C.

For the remaining compositions (D093, D101, D100, D094, and D098) the SiO₂, Al₂O₃, and SrO contents are close to that of the fibre and low linear shrinkages at both 1400° C. and 1500° C. are observed. It can also be seen that the lowest shrinkages at 1500° C. are for those binders whose composition is closest to that of the fibre used (D098 and D099).

It should also be noted that all of the compositions for which SrO is greater than 35 wt % have a low shrinkage (for example<5%) at 1400° C.

It can be advantageous to use a particulate inorganic filler in converted products. In a fully fibrous product shrinkage of the fibres is reflected in shrinkage of the whole body containing the fibres. With a particulate filler the particles act to inhibit the shrinkage of the body so that it is not proportionate to the fibre shrinkage. Advantageously the filler will have a composition close to that of the fibre to reduce the risk of adverse reaction between filler and fibre. The shot that is formed as part of the fibre forming process can be used as this filler to advantageous effect, but will increase overall board density. For thermal mass requirements the density of the board should preferably not exceed 0.5 g/cm³. Table 5 shows the results of a series of test boards made using air classified (using a British Rema Mini Split air classifier) fibre of the same composition as that used in the above mentioned tests, but with some shot added back as a filler. Compositions S113-116 and S121 were deshotted at 4000 rpm which removed all shot greater than 50 μm diameter and the stated amount of shot was added back. Composition S117 was deshotted at a lower speed resulting in approximately 50% of shot being retained so that, no addition of shot was necessary.

These results are plotted in FIG. 1 with compositions S113-116 and S121 being plotted and S117 shown as reference figures. It can be seen that addition of shot reduces shrinkage, the effect being more marked at higher temperatures. The shrinkage of boards from composition S117 is lower at most temperatures but this could be an artefact of damage caused by the deshotting process to the other samples, possible through separation of shot from the fibre (a proportion is usually attached to fibre) or through shorter fibre length. However, the principle of adding shot, or of using a fibre containing a lot of shot, does appear to be useful for making board.

TABLE 1

| | D090 | D091 | D092 | D093 | D094 | D095 | D096 | D097 | D098 | D099 | D100 | D101 |
|---|---|---|---|---|---|---|---|---|---|---|---|---|
| Water | 800 | 800 | 800 | 800 | 800 | 800 | 800 | 800 | 800 | 800 | 800 | 800 |
| SrCO₃ (Aldrich Chemical Co., | 3.57 | | | 1.79 | 1.79 | | 1.18 | 0.36 | 2.07 | 2.07 | 1.88 | 1.88 |
| Gillingham, Dorset) | | | | | | | | | | | | |
| Alumina (Disperal ™ 30/2, | | 3.85 | 0.00 | 1.92 | 0.20 | 0.41 | 0.27 | 0.02 | 0.84 | 0.84 | 0.44 | 0.44 |
| Condea Chemie GMBH, Hamburg, | | | | | | | | | | | | |
| Germany) | | | | | | | | | | | | |
| Super Standard Porcelain Clay | | | 2.97 | | 1.33 | 2.66 | 1.76 | 2.66 | | | | |
| (ECC International, St.Austell, | | | | | | | | | | | | |
| Cornwall) | | | | | | | | | | | | |
| WBB Carbonaceous Clay (Watts | | | | | | | | | 1.15 | 1.15 | 1.06 | 1.06 |
| Blake Bearne & Co PLC, | | | | | | | | | | | | |
| Newton Abbot, Devon) | | | | | | | | | | | | |
| Strontium aluminate fibre | 25 | 25 | 25 | 25 | 25 | 25 | 25 | 25 | 25 | 25 | 25 | 25 |
| Anionic Starch (Wisprofloc | | | | | | | | | 45.2 | 31.2 | 17.2 | 52.5 |
| A ™- 1% solution, Avebe UK | | | | | | | | | | | | |
| Ltd, Ulceby, North Lincolnshire)) | | | | | | | | | | | | |
| Cationic Starch (Solvitose | 100 | 100.4 | 84 | 87.7 | 39.5 | 49.8 | 24 | 54.9 | | | | |
| PLV ™- 0.5% solution, Avebe UK | | | | | | | | | | | | |
| Ltd.) | | | | | | | | | | | | |
| Latex (Acronal LA420S ™- | 1.25 | 1.25 | 1.25 | 1.25 | 1.25 | 1.25 | 1.25 | 1.25 | 1.25 | 1.25 | 1.25 | 1.25 |
| BASF, Cheadle, Cheshire) | | | | | | | | | | | | |
| Flocculating agent (Percol | | 15.1 | 20 | 17.9 | 5.9 | 17 | 8 | 9.5 | 43.5 | | 40.2 | |
| 230L ™ 0.2% solution CIBA | | | | | | | | | | | | |
| Specialities, Macclesfield) | | | | | | | | | | | | |

TABLE 2

| | | | | | | WBB | |
|---|---|---|---|---|---|---|---|
| | | | | | Super Standard | Carbonaceous | Wyoming |
| | SrCO3 | Disperal P2 | Cerasol* | Bacosol 3C* | Porcelain Clay | Clay | Bentonite |
| Na₂O | <0.05. | 0.005 | 0.001 | 0.15 | 0.15 | 0.11 | 2.21 |
| MgO | <0.05. | | | | 0.22 | 0.23 | 2.43 |
| Al₂O₃ | <0.05. | 65 | 73 | 85 | 38 | 17.64 | 20.10 |
| SiO₂ | 0.08 | 0.025 | 0.022 | 0.002 | 47 | 26.02 | 63.40 |
| P₂O₅ | | | | | | 0.05 | 0.05 |
| SO₃ | | | | | | | |
| K₂O | <0.05. | | | | 0.8 | 0.88 | 0.54 |
| CaO | 0.14 | | | | 0.1 | 0.44 | 1.31 |
| TiO₂ | <0.05. | | | | 0.03 | 0.41 | 0.16 |
| Fe₂O₃ | 0.06 | 0.02 | 0.016 | | 0.39 | 1.24 | 3.99 |
| ZnO | | | | | | | |
| SrO | 68 | | | | | | |
| Y₂O₃ | | | | | | | |
| ZrO₂ | | | | | | | |
| BaO | 1.36 | | | | | 0.03 | 0.06 |
| HfO₂ | | | | | | | |
| Loss on ignition | 29.4 | | 26.9 | 15 | 13 | 52.70 | 6.3 |
| Total | 99.0 | 65.1 | 99.9 | 100.2 | 99.7 | 99.8 | 100.6 |
| pH | | 2 | 4 | 5.5 | | | |

*BA Chemicals, Gerrards Cross, Buckinghamshire

TABLE 3

| | % linear shrinkage (5 hours at | | | Calculated inorganic binder | | | Deviation from mean fibre composition | | |
|---|---|---|---|---|---|---|---|---|---|
| | temperature indicated) | | | composition | | | Absolute value | Absolute value | Absolute value |
| <-Test number | 1400° C. | 1500° C. | 1550° C. | % SrO | % Al₂O₃ | % SiO₂ | % SrO − 57.8 | % Al₂O₃ − 29.4 | % SiO₂ − 12.1 |
| D092 | 17.73 | | | 0 | 44.1 | 56 | 57.8 | 14.7 | 43.8 |
| D095 | 12.03 | | | 0 | 50 | 50 | 57.8 | 20.6 | 37.9 |
| D097 | 9.8 | | | 10 | 40 | 50 | 47.8 | 10.6 | 37.9 |
| D096 | 5.54 | 7.56 | | 33 | 33 | 33 | 24.8 | 3.6 | 20.9 |
| D091 | 4.88 | | | 0 | 100 | 0.00 | 57.8 | 70.6 | 12.1 |
| D090 | 1.75 | 15.01 | | 100 | 0 | 0 | 42.2 | 29.4 | 12.1 |
| D093 | 3.13 | 3.95 | | 50 | 50 | 0 | 7.8 | 20.6 | 12.1 |
| D101 | 1.46 | 2.85 | 8.8 | 63.6 | 23 | 13.4 | 7.8 | 4.4 | 12.9 |
| D100 | 2.11 | 3.42 | 4.5 | 63.6 | 23 | 13.4 | 5.8 | 6.4 | 1.3 |
| D094 | 2.95 | 3.53 | | 50 | 25 | 25 | 5.8 | 6.4 | 1.3 |
| D098 | 1.62 | 1.96 | 5.16 | 58 | 30 | 12 | 0.2 | 0.6 | 0.1 |
| D099 | 1.94 | 2.67 | 6.13 | 58 | 30 | 12 | 0.2 | 0.6 | 0.1 |

TABLE 4

| | Run Number | | | |
|---|---|---|---|---|
| Oxide | 1 | 2 | 3 | Mean |
| Na₂O | 0.18 | 0.18 | 0.16 | 0.17 |
| Al₂O₃ | 29.5 | 29.4 | 29.2 | 29.4 |
| SiO₂ | 12.2 | 12.2 | 12.0 | 12.1 |
| CaO | 0.12 | 0.12 | 0.11 | 0.12 |
| Fe₂O₃ | 0.05 | 0.05 | <0.05 | 0.03 |
| SrO | 58.3 | 57.2 | 57.9 | 57.8 |
| Y₂O₃ | 0.08 | 0.08 | 0.08 | 0.08 |
| BaO | 0.07 | 0.07 | 0.06 | 0.07 |
| L.O.I. | 0.22 | 0.31 | 0.16 | 0.23 |
| Total | 100.7 | 99.6 | 99.7 | 100.0 |

TABLE 5

| | Deshot | | | Linear Shrinkage | | Calculated |
|---|---|---|---|---|---|---|
| Mix | speed | Binder | Shot | 1400° C. | 1500° C. | Density |
| S113 | 4000 rpm | 0.5% PLV | 0 | 3.45 | 6.64 | 0.25 |
| | | starch | | | | |
| S114 | 4000 rpm | 0.5% PLV | 25 | 3.09 | 5.84 | 0.30 |
| | | starch | | | | |
| S115 | 4000 rpm | 0.5% PLV | 40 | 2.82 | 5.04 | 0.39 |
| | | starch | | | | |
| S116 | 4000 rpm | 0.5% PLV | 50 | 3.1 | 5.72 | 0.41 |
| | | starch | | | | |
| S121 | 4000 rpm | 0.5% PLV | 66 | | 4.41 | 0.76 |
| | | starch | | | | |
| S117 | 2500 rpm | 0.5% PLV | ˜50 | 2.57 | 4.75 | 0.42 |
| | | starch | | | | |

### EXAMPLE 2

Following the measurements shown in Table 3, further testing was done with a range of binder compositions and using different clays. A sample using only the green binder (which had no high temperature strength) was also tested. The results are indicated in Table 6 which shows that the 35% SrO level does provide a clear difference to 1400° C. shrinkages.

TABLE 6

| | | | | % linear shrinkage | | | |
|---|---|---|---|---|---|---|---|
| | Calculated inorganic binder | | | (5 hours at temperature | | | |
| Test | composition | | | indicated) | | | |
| number ↓ | SrO | Al₂O₃ | SiO₂ | 1400° C. | 1500° C. | 1550° C. | Clay used |
| Fibre alone | | | | 2.81 | 3.44 | 8.92 | |
| D091 | 0.0 | 100.0 | 0.0 | 4.88 | Melted | | |
| D095 | 0.0 | 50.0 | 50.0 | 12.03 | | | Super Standard |
| | | | | | | | Porcelain Clay |
| D092 | 0.0 | 44.7 | 55.3 | 17.73 | | | Super Standard |
| | | | | | | | Porcelain Clay |
| D181 | 0.0 | 25.0 | 75.0 | 16.16 | 27.77 | melted | Bentonite |
| D146 | 10.0 | 90.0 | 0.0 | 5.16 | 19.92 | 25.38 | |
| D097 | 10.0 | 40.0 | 50.0 | 9.8 | | | Super Standard |
| | | | | | | | Porcelain Clay |
| D145 | 20.0 | 80.0 | 0.0 | 5.76 | 13.34 | 19.55 | |
| D147 | 20.0 | 70.0 | 10.0 | 3.96 | 9.13 | 11.53 | Super Standard |
| | | | | | | | Porcelain Clay |
| D182 | 20.0 | 70.0 | 10.0 | 4.79 | 9.96 | 14.82 | Bentonite |
| D183 | 20.0 | 60.0 | 20.0 | 5.12 | 12.94 | 17.54 | Bentonite |
| D148 | 20.0 | 60.0 | 20.0 | 4.59 | 14.75 | 19.04 | Super Standard |
| | | | | | | | Porcelain Clay |
| D133 | 20.0 | 40.0 | 40.0 | 9.28 | 27.5 | | WBB Carbonaceous |
| | | | | | | | Clay |
| D180 | 20.0 | 20.0 | 60.0 | 7.01 | 15.05 | 22.22 | Bentonite |
| D144 | 30.0 | 70.0 | 0.0 | 4.71 | 9.44 | 10.25 | |
| D179 | 30.0 | 60.0 | 10.0 | 4.25 | 4.68 | 5.04 | Bentonite |
| D127 | 30.0 | 60.0 | 10.0 | 3.11 | 21.7 | | Super Standard |
| | | | | | | | Porcelain Clay |
| D178 | 30.0 | 50.0 | 20.0 | 4.37 | 6.75 | 7.84 | Bentonite |
| D128 | 30.0 | 50.0 | 20.0 | 5.17 | 20.97 | | Super Standard |
| | | | | | | | Porcelain Clay |
| D152 | 30.0 | 50.0 | 20.0 | 4.8 | | | WBB Carbonaceous |
| | | | | | | | Clay |
| D177 | 30.0 | 40.0 | 30.0 | 4.6 | 7.21 | 10.11 | Bentonite |
| D134 | 30.0 | 40.0 | 30.0 | 6.73 | 24.94 | | WBB Carbonaceous |
| | | | | | | | Clay |
| D135 | 30.0 | 30.0 | 40.0 | 6.98 | 20.03 | | WBB Carbonaceous |
| | | | | | | | Clay |
| D122 | 30.0 | 20.0 | 50.0 | 4.41 | 9.11 | | Bentonite |
| D096 | 33.3 | 33.3 | 33.3 | 5.54 | 7.56 | | Super Standard |
| | | | | | | | Porcelain Clay |
| D114 | 40.0 | 60.0 | 0.0 | 3.51 | 4.26 | 5.98 | |
| D172 | 40.0 | 50.0 | 10.0 | 4.04 | 4.26 | 6.33 | Bentonite |
| D115 | 40.0 | 50.0 | 10.0 | 3.17 | 4.05 | 7.19 | Super Standard |
| | | | | | | | Porcelain Clay |
| D153 | 40.0 | 50.0 | 10.0 | 3.23 | 3.13 | Melted | WBB Carbonaceous |
| | | | | | | | Clay |
| D149 | 40.0 | 45.0 | 15.0 | 3.96 | 5.69 | 6.63 | Super Standard |
| | | | | | | | Porcelain Clay |
| D173 | 40.0 | 40.0 | 20.0 | 3.92 | 4.14 | 4.74 | Bentonite |
| D107 | 40.0 | 40.0 | 20.0 | 3.52 | 4.07 | 13.11 | Super Standard |
| | | | | | | | Porcelain Clay |
| D136 | 40.0 | 40.0 | 20.0 | 2.54 | 10.45 | | WBB Carbonaceous |
| | | | | | | | Clay |
| D112 | 40.0 | 30.0 | 30.0 | 2.93 | 3.3 | 4.46 | WBB Carbonaceous |
| | | | | | | | Clay |
| D174 | 40.0 | 30.0 | 30.0 | 4.87 | 4.65 | 5.4 | Bentonite |
| D150 | 40.0 | 30.0 | 30.0 | 3.15 | 3.36 | Melted | Super Standard |
| | | | | | | | Porcelain Clay |
| D175 | 40.0 | 20.0 | 40.0 | 3.69 | 4.03 | 4.7 | Bentonite |
| D093 | 50.0 | 50.0 | 0.0 | 3.13 | 3.95 | 2.6 | |
| D116 | 50.0 | 45.0 | 5.0 | 2.8 | 4.15 | 7.22 | Super Standard |
| | | | | | | | Porcelain Clay |
| D169 | 50.0 | 40.0 | 10.0 | 3.74 | 3.72 | 6.3 | Bentonite |
| D106 | 50.0 | 40.0 | 10.0 | 2.89 | 3.34 | 6.5 | Super Standard |
| | | | | | | | Porcelain Clay |
| D137 | 50.0 | 40.0 | 10.0 | 2.22 | 4.81 | 11.65 | WBB Carbonaceous |
| | | | | | | | Clay |
| D170 | 50.0 | 30.0 | 20.0 | 3.35 | 3.49 | 5.28 | Bentonite |
| D129 | 50.0 | 30.0 | 20.0 | 2.96 | 4.82 | 7.52 | Super Standard |
| | | | | | | | Porcelain Clay |
| D094 | 50.0 | 25.0 | 25.0 | 2.95 | 3.53 | 1.13 | Super Standard |
| | | | | | | | Porcelain Clay |
| D113 | 50.0 | 20.0 | 30.0 | 3.02 | 3.12 | 4.27 | WBB Carbonaceous |
| | | | | | | | Clay |
| D171 | 50.0 | 20.0 | 30.0 | 2.95 | 2.76 | 4.56 | Bentonite |
| D126 | 50.0 | 12.0 | 38.0 | 3.87 | 4.15 | 12.09 | Bentonite |
| D110 | 52.7 | 27.3 | 20.0 | 1.66 | 2.75 | 5.61 | WBB Carbonaceous |
| | | | | | | | Clay |
| D098 | 58.0 | 30.0 | 12.0 | 1.62 | 1.96 | 5.16 | WBB Carbonaceous |
| | | | | | | | Clay |
| D099 | 58.0 | 30.0 | 12.0 | 1.94 | 2.67 | 6.13 | WBB Carbonaceous |
| | | | | | | | Clay |
| D159 | 58.0 | 30.0 | 12.0 | 1.65 | 3.06 | 11.83 | Super Standard |
| | | | | | | | Porcelain Clay |
| D143 | 60.0 | 40.0 | 0.0 | 2.46 | 3.92 | 13.1 | |
| D105 | 60.0 | 35.0 | 5.0 | 2.5 | 4.29 | 17.08 | Super Standard |
| | | | | | | | Porcelain Clay |
| D130 | 60.0 | 30.0 | 10.0 | 1.45 | 2.52 | 8.88 | Super Standard |
| | | | | | | | Porcelain Clay |
| D167 | 60.0 | 30.0 | 10.0 | 3.31 | 4.25 | 8.95 | Bentonite |
| D168 | 60.0 | 20.0 | 20.0 | 2.54 | 3.87 | 9.71 | Bentonite |
| D131 | 60.0 | 20.0 | 20.0 | 2.19 | 4.05 | 10.08 | Super Standard |
| | | | | | | | Porcelain Clay |
| D138 | 60.0 | 20.0 | 20.0 | 2.05 | 2.6 | 11.37 | WBB Carbonaceous |
| | | | | | | | Clay |
| D123 | 60.0 | 10.0 | 30.0 | 2.41 | 2.47 | 8.36 | Bentonite |
| D111 | 63.6 | 23.0 | 13.4 | 1.87 | 4.06 | 9.31 | WBB Carbonaceous |
| | | | | | | | Clay |
| D142 | 70.0 | 30.0 | 0.0 | 2.13 | 5.57 | 21.62 | |
| D117 | 70.0 | 25.0 | 5.0 | 2.99 | 9.28 | | Super Standard |
| | | | | | | | Porcelain Clay |
| D166 | 70.0 | 20.0 | 10.0 | 2.37 | 4.34 | 9.52 | Bentonite |
| D132 | 70.0 | 20.0 | 10.0 | 1.22 | 2.27 | 13.75 | Super Standard |
| | | | | | | | Porcelain Clay |
| D120 | 70.0 | 20.0 | 10.0 | 1.82 | 5.12 | 16.16 | WBB Carbonaceous |
| | | | | | | | Clay |
| D103 | 70.0 | 15.0 | 15.0 | 1.75 | 2.54 | 4.44 | Super Standard |
| | | | | | | | Porcelain Clay |
| D151 | 70.0 | 15.0 | 15.0 | 1.03 | 5.27 | | WBB Carbonaceous |
| | | | | | | | Clay |
| D124 | 70.0 | 10.0 | 20.0 | 1.73 | 4.12 | 19.82 | Bentonite |
| D104 | 75.0 | 20.0 | 5.0 | 2.61 | 9.38 | | Super Standard |
| | | | | | | | Porcelain Clay |
| D141 | 80.0 | 20.0 | 0.0 | 1.48 | 6.44 | 25.62 | |
| D118 | 80.0 | 15.0 | 5.0 | 4 | 13.17 | | Super Standard |
| | | | | | | | Porcelain Clay |
| D139 | 80.0 | 10.0 | 10.0 | −0.14 | 2.34 | 13.05 | WBB Carbonaceous |
| | | | | | | | Clay |
| D165 | 80.0 | 10.0 | 10.0 | 1.88 | 6.11 | 14.82 | Bentonite |
| D102 | 80.0 | 10.0 | 10.0 | 1.28 | 4.95 | 26.27 | Super Standard |
| | | | | | | | Porcelain Clay |
| D125 | 80.0 | 5.0 | 15.0 | 1.48 | 4.42 | 23.17 | Bentonite |
| D140 | 90.0 | 10.0 | 0.0 | 1.58 | 8.99 | 24.03 | |
| D119 | 90.0 | 5.0 | 5.0 | 2.73 | 12.81 | | Super Standard |
| | | | | | | | Porcelain Clay |
| D090 | 100.0 | 0.0 | 0.0 | 1.75 | 15.01 | | |

The clay used has little effect on shrinkage at 1400° C. but may have an effect at higher temperatures. (possibly through impurities in the clays).

The closer the SrO content of the binder is to the SrO content of the fibre the more reproducibly low is the shrinkage. Preferably the SrO content of the binder is >40 wt % and more preferably>50 wt %. The SrO content is also preferably<90 wt %, more preferably<80 wt %, still more preferably<70 wt %. Advantageously the SrO content of the binder is within ±15 wt %, (more preferably±10 wt % and still more preferably±5 wt %. of the SrO content of the fibre.

### EXAMPLE 3

A clay free formulation for use in vacuum forming strontium aluminium silicate boards may comprise:

TABLE 7

| Material | Quantity |
|---|---|
| Water | ˜10 liters |
| Strontium Aluminate fibre (of composition as mentioned | 100 g |
| above) | |
| Strontium Carbonate powder < 5 micron | 12.5 g |
| Alumina sol (20% Al₂O₃) (e.g. Nyacol Al20 ™ colloidal | 21.85 g |
| alumina from Nyacol Products Inc.) | |
| Silica sol (25.5% SiO₂- 3.8% Al₂O₃) (e.g. | 6.35 g |
| Bindzil CAT 220 ™ colloidal silica from Akzo Nobel) | |
| Organic charge modifier (e.g. Alcofix 110 ™, a cationic | 2.5 g |
| polymer from Ciba Specialty Chemicals) | |
| Starch (cold water soluble) (e.g. Wisprofloc A ™, a | 3.07 g |
| pregelatinized | |
| carboxymethyl ether of potato starch from Avebe) | |

The aims of any binder system for such converted products are:

1) To be suitable for vacuum forming—all ingredients should flocculate in as stable a manner as possible

2) To bind fibres well, both when green and when fired

3) Not to have an adverse effect on the fibre

In the above mix the strontium carbonate (which goes into the mix as a fine powder dispersed in water) is present as a source of strontium oxide, the alumina sol supplies aluminium oxide and a degree of strength once fired, and the colloidal silica supplies the silica and a lot of bonding, especially around 650° C. Without the colloidal silica the material may well be more refractory, but after firing at 650° C. for half an hour ( i.e. when the starch has burnt out, but before any sintering has taken place), will be very weak.

The colloidal alumina is in cationic form to match the charge of the cationic colloidal silica so as to be compatible and not cause flocculation prematurely. Between the colloidal silica and colloidal alumina there is not enough charge to flocculate with the desired amount of anionic starch, (predetermined by the green strength desired), and so cationic polymer is added to boost the weak cationic contribution from the silica and alumina [Of course, the charges may be chosen otherwise to provide an anionic silica and alumina and a cationic starch and anionic polymer. This may be a cheaper option.].

The elemental composition of the inorganic binder is approximately the same as the fibre; this is to promote stability and in this respect the strontium is most important element. The above binder composition has the approximate relative proportions 58.2 wt % SrO, 30.9 wt % Al₂O₃, and 10.9 wt % SiO₂.

The order of addition and charge of components is chosen so that flocculation only takes place once all the ingredients have been added.

### EXAMPLE 4

In a series of tests to look at the variability of strength of the products a range of boards were made to the recipe of Table 8 below, with some variation of the amount of the Alcofix™ product for some samples.

The fibres used were either chopped or bulk strontium aluminate fibre having some zirconia present in the fibres. X-ray fluorescence anaylsis of these fibres gave the composition shown in Table 9 below.

TABLE 8

| Material | % (based on weight of fibre) |
|---|---|
| Water | 2,500 |
| Alumina sol (Bacosol 3C) | 14.84 |
| Strontium carbonate powder | 12.56 |
| Strontium aluminate fibre | 100 |
| Cationic silica sol (Levasil 200S, 30%) | 7.44 |
| Cationic Polymer (Alcofix 110 ™) | 2.44 |
| Anionic Starch (Wisprofloc A) (powder) | 3.00 |

(For sample D237 1.5 times the above amount of Alcofix ™ was used, and for D238 and T149 twice the amount of Alcofix ™ was used).

TABLE 9

| Component | wt. % |
|---|---|
| SrO | 56.2 |
| Al₂O₃ | 29.5 |
| SiO₂ | 12.8 |
| ZrO₂ | 0.93 |
| CaO | 0.13 |
| Na₂O | 0.09 |
| BaO | 0.07 |
| Fe₂O₃ | 0.07 |
| Y₂O₃ | 0.06 |
| Loss on ignition | 0.29 |
| MgO | <0.05 |
| Total | 100.2 |

Boards were formed from these fibres and to the recipe by the process of:

1. Adding Bacosol 3C to part of the water

2. Strontium carbonate was added to this to form a first mix

3. Fibre was added to the remaining water and stirred to form a second mix

4. The first mix was then added to the second mix

5. Colloidal silica was added to this mixture.

6. Alcofix was then added

7. Starch was added for flocculation

8. The resultant flocced slurry was then used to form sample boards by vacuum casting. The casting pressure was varied for some boards so as to increase density.

The results are tabulated below in Table 10 and shown graphically in FIG. 2.

In Table 10:

The column “Fibre” indicates whether the fibre used was chopped, bulk, chopped and bulk, and whether added Alcofix™ was used.

The column “Board” is an identifier for the sample.

The column “Density” is the density of the sample.

The column “TBS” is the transverse breaking strain measured by three point bend test.

It can be seen that although the majority of the samples show a correlation of strength with density (as would be expected), the samples with an increased Alcofix™ content have a considerably higher strength than would be expected from the density of the boards. This is particularly apparent when the strengths are plotted against density as in FIG. 2.

Alcofix™ is a cationic polymer of the polyDADMAC type (polydiallyl, dimethyl ammonium chloride) having the monomer unit

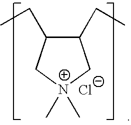

The applicants speculate that using an excess of polyDADMAC (excess in the sense of more than is required simply to form stable flocs with clear water) allows the polyDADMAC to adhere to and impart a charge to the fibre, so forming looser, softer flocs which can entangle and bind together more strongly than would tight flocs.

TABLE 10

| Fibre | Board | Density (g/cm²) | TBS (Mpa) |
|---|---|---|---|
| Chopped | T142 | 0.32 | 0.36 |
| | T140 | 0.33 | 0.07 |
| | T141 | 0.48 | 0.68 |
| | T139 | 0.54 | 0.63 |
| Bulk | T144 | 0.44 | 0.27 |
| | T146 | 0.44 | 0.33 |
| | T145 | 0.59 | 0.88 |
| | T143 | 0.63 | 1.00 |
| | TC (UK) | 0.56 | 0.94 |
| Chopped + extra | D237 | 0.58 | 1.78 |
| Alcofix ™ | D238 | 0.53 | 1.86 |
| | T149 | 0.45 | 1.35 |
| Mixed Bulk & | T150 | 0.49 | 0.8 |
| Chopped Fibre | | | |

1. A refractory material comprising a strontium aluminate refractory fibres and an inorganic binder comprising when fired greater than 35 wt % strontium oxide.

2. A refractory material as claimed in claim 1 comprising strontium aluminate refractory fibres and an inorganic binder having the composition when fired (based upon the amounts of strontium, aluminium and silicon present calculated as oxide) comprising:
SiO₂ silicon oxide content of strontium aluminate fibre ±20 wt %.

3. A refractory material as claimed in claim 1 or claim 2, in which the inorganic binder comprises when fired:
Al₂O₃ aluminium oxide content of strontium aluminate fibre±65 wt %

4. A refractory material as claimed in claim 3, in which the inorganic binder comprises when fired:
Al₂O₃ aluminium oxide content of strontium aluminate fibre±25 wt %.

5. A refractory material as claimed in claim 4, in which the inorganic binder comprises when fired:
Al₂O₃ aluminium oxide content of strontium aluminate fibre±20 wt %.

6. A refractory material as claimed in claim 5, in which the inorganic binder comprises when fired:
Al₂O₃ aluminium oxide content of strontium aluminate fibre±15 wt %.

7. A refractory material as claimed in claim 6, in which the inorganic binder comprises when fired:
Al₂O₃ aluminium oxide content of strontium aluminate fibre±10 wt %.

8. A refractory material as claimed in claim 7, in which the inorganic binder comprises when fired:
Al₂O₃ aluminium oxide content of strontium aluminate fibre±5 wt %.

9. A refractory material as claimed in any preceding claim, in which the inorganic binder comprises when fired:
SrO>40 wt %.

10. A refractory material as claimed in claim 9, in which the inorganic binder comprises when fired:
SrO>50 wt %.

11. A refractory material as claimed in any preceding claim, in which the inorganic binder comprises when fired:
SrO<90 wt %.

12. A refractory material as claimed in claim 11, in which the inorganic binder comprises when fired:
SrO<80 wt %.

13. A refractory material as claimed in any of claims 9 to 12, in which the inorganic binder comprises when fired:
SrO strontium oxide content of strontium aluminate fibre±15 wt %.

14. A refractory material as claimed in claim 13, in which the inorganic binder comprises when fired:
SrO strontium oxide content of strontium aluminate fibre±10 wt %.

15. A refractory material as claimed in claim 14, in which the inorganic binder comprises when fired:
SrO strontium oxide content of strontium aluminate fibre±5 wt %.

16. A refractory material as claimed in any preceding claim, in which the inorganic binder comprises when fired:
SiO₂ silicon oxide content of strontium aluminate fibre±15 wt %.

17. A refractory material as claimed in claim 16, in which the inorganic binder comprises when fired:
SiO₂ silicon oxide content of strontium aluminate fibre±10 wt %.

18. A refractory material as claimed in claim 17, in which the inorganic binder comprises when fired:
SiO₂ silicon oxide content of strontium aluminate fibre±5 wt %.

19. A refractory material as claimed in any preceding claim additionally comprising an inorganic filler.

20. A refractory material as claimed in claim 19, in which the inorganic filler has the composition (based upon the amounts of strontium, aluminium and silicon present calculated as oxide) comprising:
SiO₂ silicon oxide content of strontium aluminate fibre±20 wt %.

21. A refractory material as claimed in claim 20, in which the inorganic filler comprises:
Al₂O₃ aluminium oxide content of strontium aluminate fibre±65 wt %

22. A refractory material as claimed in claim 21, in which the inorganic filler comprises:
Al₂O₃ aluminium oxide content of strontium aluminate fibre±25 wt %.

23. A refractory material as claimed in any of claims 19 to 22, in which the inorganic filler comprises:
SrO>40 wt %.

24. A refractory material as claimed in claim 23, in which the inorganic filler comprises:
SrO>50 wt %.

25. A refractory material as claimed in claim 23 or claim 24, in which the inorganic filler comprises:
SrO<90 wt %.

26. A refractory material as claimed in claim 26, in which the inorganic filler comprises when fired:
SrO<80 wt %.

27. A refractory material as claimed in any of claims 19 to 25, in which the inorganic filler comprises when fired:
SrO strontium oxide content of strontium aluminate fibre±15 wt %.

28. A refractory material as claimed in claim 27, in which the inorganic filler comprises when fired:
SrO strontium oxide content of strontium aluminate fibre±10 wt %.

29. A refractory material as claimed in claim 28, in which the inorganic filler comprises when fired:
SrO strontium oxide content of strontium aluminate fibre±5 wt %.

30. A refractory material as claimed in claim 19, in which the inorganic filler comprises shot from the manufacture of the fibre.

31. A refractory material as claimed in any preceding claim comprising, before firing, both a latex binder and a starch.

32. A refractory material as claimed in any preceding claim comprising, before firing, a cationic polymer.

33. A refractory material as claimed in claim 32, in which the cationic polymer is a polyDADMAC.

34. A method of making a refractory material comprising a strontium aluminate refractory fibre and an inorganic binder containing strontium and aluminium in oxide form comprising the steps of:
a) forming a green body from a strontium aluminate refractory fibre and a particulate material; and,
b) firing the green body to convert the particulate material into an inorganic binder having the composition set out in any of claims 1 to 10.

35. A method of making a refractory material as claimed in claim 34, in which the particulate material comprises an aluminium containing particulate material, and a strontium containing particulate material.

36. A method of making a refractory material as claimed in claim 34 or 35, in which the refractory material is formed by deposition from a slurry.

37. A method of making a refractory material as claimed in claim 36, in which the slurry comprises:
a) strontium aluminate refractory fibres
b) particulate material capable of forming the inorganic binder containing strontium and aluminium
c) an organic binder.

38. A method of making a refractory material as claimed in claim 37, in which the slurry comprises an organic charge modifier.

39. A method of making a refractory material as claimed in claim 38, in which the organic charge modifier comprises a cationic polymer.

40. A method of making a refractory material as claimed in claim 39, in which the cationic polymer is a polyDADMAC.
